(19) United States
(12) Patent Application Publication
(10) Pub. No.: US 2012/0168054 A1
(43) Pub. Date: Jul. 5, 2012

(54) USE OF SILICONES TO IMPROVE FIBERGLASS INSULATION PRODUCTS

(75) Inventors: Liang Chen, New Albany, OH (US); William E. Downey, Granville, OH (US); Jesus M. Hernandez-Torres, Pataskala, OH (US); Ying Peng, New Albany, OH (US); Jonathan Davis, Granville, OH (US)

(73) Assignee: OWENS CORNING INTELLECTUAL CAPITAL, LLC, Toledo, OH (US)

(21) Appl. No.: 13/338,316

(22) Filed: Dec. 28, 2011

Related U.S. Application Data
(60) Provisional application No. 61/429,677, filed on Jan. 4, 2011.

(51) Int. Cl. B32B 37/12; B32B 37/14; B05D 3/00; B05D 5/00; B32B 37/00

(52) U.S. Cl. 156/62.2; 427/256; 427/258; 427/299

(57) ABSTRACT

Dispersions of reactive polysiloxanes are applied to fibrous products, such as construction panels to provide improved properties, like better resistance to staining and discoloration and better adhesion of facer layers The reactive polysiloxane may be applied directly to the fibrous product or mixed into binder compositions prior to application; and may be applied substantially uniformly or non-uniformly. The construction panels may form wall and/or ceiling panels. The reactive polysiloxane may include polysiloxanes functionalized with any of hydrogen, amino, hydroxyl or carboxyl reactive functionalities.

### CROSS-REFERENCE TO RELATED APPLICATIONS

This application claims the benefit of provisional patent application Ser. No. 61/429,677, filed Jan. 4, 2011 and titled: Water Resistant Insulation and Method, which is incorporated herein in its entirety.

### BACKGROUND OF THE INVENTION

The present invention relates generally to the field of fiberglass insulation, including panels such as ceiling boards and tiles, wall panels, duct boards, pipe and molded or formed insulation products, and methods to improve the properties thereof, more specifically, water resistance, stain resistance and adhesion of facer layers.

Fibrous insulation and construction panels are typically manufactured by fiberizing a molten composition of polymer, glass or other mineral material to form fine fibers and depositing the fibers on a collecting conveyor to form a batt or a blanket. Mineral fibers, such as glass fibers, are typically used in insulation products. A binder composition may optionally be used to bond the fibers together where they contact each other. During the manufacturing process the some insulation products are formed and cut to provide sizes generally dimensioned to be compatible with standard construction practices, e.g. standard sized wall or ceiling panels having widths and/or length adapted for specific building practices. Some insulation products also incorporate a facing layer or material on at least one of the major surfaces. In many cases the facing material is provided as a vapor barrier, while in other insulation products, such as binderless products, the facing material improves the product integrity. In yet other applications, the facer may be an aesthetic or decorative surface as described below. Other insulation products may be used on structures such as, for example, pipes, ducts, appliances and other devices. The use of insulation on these structures assists to maintain a thermal difference between the structure and the environment. However, in some environments, moisture may be present and may infiltrate the insulation. This can cause the insulation to be less effective than intended and cause other issues.

In binders used for fiberglass panel manufacture, it is known to add mineral or vegetable oils or dispersions of polydimethylsiloxane (PDMS) fluids or silicone emulsions to binder dispersions as any of defoaming agents, moisture resistant agents, or dust suppressing agents. (see e.g. WO 2011/044490, published Apr. 14, 2011). In addition, silicones have been used in binderless insulation products as a lubricant for glass fibers. (see e.g. U.S. Pat. No. 6,562,257 to Chen, et al.)

One type of insulation product is a medium density rigid board that may be used for ceiling or wall panels, collectively “construction panels.” In such construction panels a finished facing layer or “facer” is frequently applied to provide a more desirable texture, pattern or color to the construction panel. A problem with some construction panels is the tendency for water or moisture to seep or bleed through the fiberglass panel and cause staining and/or discoloration of the finished surface. This problem may occur as a result of a leak in a plumbing system or in high humidity areas in the absence of any leaks. This is particularly troublesome when the water or moisture dissolves and washes brown or otherwise colored binder products from the fiber matrix and into the finish layer.

Another problem arises when adhesives are used to apply finish layer or facer to the underlying fiberglass panel. Most typically with hydrophilic surfaces, the adhesives are absorbed quickly into the fiberglass, requiring excessive amounts of adhesive or causing poor adhesion of the finish or facer layer.

The present invention seeks to address these problems and others.

### SUMMARY OF THE INVENTION

In general, the invention relates to the addition of silicone additives to fibrous insulation products. The addition results in certain improved properties that are unexpected; for example, improved water resistance, improved stain resistance and improved adhesion with facer layers.

Thus, in a first aspect, the invention provides a method of improving the resistance to staining or discoloration of a fibrous product construction panel, the method comprising:

forming the fibrous product from a plurality of mineral fibers, and

applying a reactive polysiloxane to at least some of the fibers of the fibrous product, wherein the fibrous product is more resistant to staining or discoloration than a fibrous product made without the reactive polysiloxane.

In a second aspect, the invention provides a method of improving the facing adhesion properties of a fibrous product construction panel, the method comprising:

forming the fibrous product from a plurality of mineral fibers;

applying a reactive polysiloxane to at least some of the fibers of the fibrous product; and

applying a facing to the fibrous product with an adhesive;

wherein the facing more strongly adheres to the fibrous product than to a fibrous product made without the reactive polysiloxane.

In a third aspect, the invention provides a method of improving the water resistance properties—such as absorption and wicking tension—of a fibrous insulation product, the method comprising:

forming the fibrous product from a plurality of mineral fibers;

applying to at least some of the fibers of the fibrous product an additive selected from a silicone emulsion and a polyglycerine;

wherein the insulation product is more resistant to water than a fibrous product made without the reactive polysiloxane.

In each of the aspects described above, the silicone may be a polymer having from about 5 to about 100 siloxane units, ie. a polysiloxane. The polysiloxane may be a reactive polysiloxane, with each siloxane unit having a reactive functional group, which may be selected from a polyalkylamino siloxane, a polyalkylhydroxyl siloxane and a polyalkylhydrogen siloxane, such as a polymethylhydrogen siloxane. The reactive silicones may be distributed or applied substantially uniformly throughout the fibrous product, or they may be non-uniformly concentrated near at least one major surface the fibrous product.

In each of the aspects described above, the silicone may be applied separately or as part of a binder solution or dispersion, if a binder is used. Useful binder dispersions include a thermosetting, curable binder systems comprising a polyhydroxyl compound and a polycarboxylic acid crosslinking agent, such as polyacrylic/polyhydric alcohol binders, and carbohydrate-based binders. The carbohydrate-based binders may include a polysaccharide selected from a starch, a maltodextrin, a dextrin and a syrup; or it may be a mono saccharide.

In some embodiments, the method may further comprise applying a facing to the fibrous product. Specific fibrous insulation products made using the invention include light to medium density batts for residential insulation, medium to high density boards for construction panels for walls and/or ceilings, and rolled, folded or molded insulation for specific adapted uses like pipes, ducts, appliances, automotive and other applications.

In one embodiment, an insulation product having fibers bound by a binder is provided. The binder can include silicone emulsion or polyglycerine as an additive to the binder chemistry to improve water resistance of the final insulation products. The weight percentage of the binder additives is in the range of up to 2.5% by weight of fiber material (e.g., glass). In one preferred embodiment, the weight percentage of the binder additives is approximately 0.01% to approximately 1% weight of fiber material (e.g., glass).

A feature of the present invention is ceiling tiles and wall panels with improved resistance to water staining, such as may be caused by leakage or high moisture environments. Another feature is improved adhesion of the facer layer to the fibrous substrate, possibly resulting in savings of adhesive costs.

Another feature is the use of additives like silicones or polyglycerine to improve water resistance properties like absorption and wicking tension.

Other advantages and features and variations will become apparent to those skilled in the art from the following detailed description of various embodiments, when read in light of the accompanying drawings.

### BRIEF DESCRIPTION OF THE DRAWINGS

The accompanying drawings, incorporated herein and forming a part of the specification, illustrate the present invention in its several aspects and, together with the description, serve to explain the principles of the invention. In the drawings, the thickness of the lines, layers, and regions may be exaggerated for clarity.

FIG. 1 is a diagrammatic side elevation view of fibrous product manufacturing line;

FIGS. 2A-2B, respectively, are end and cross-sectional views of an embodiment of pipe insulation;

FIG. 2C is a partially sectioned, perspective view of a representative ceiling board with a decorative facing layer;

FIG. 3 is an edge view of a board insulation product;

FIG. 4 is a cross-sectional view of a duct insulation product;

FIGS. 5 and 6 are graphs representing data from Examples 4 and 5; and

FIG. 7A to 7D are comparative photos illustrating the stain resistance of the invention on ceiling tiles as described in Examples 1-3.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

Unless otherwise indicated, all numbers expressing ranges of magnitudes, such as angular degrees or web speeds, quantities of ingredients, properties such as molecular weight, reaction conditions, dimensions and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

The term “R-value” is the commercial unit used to measure the effectiveness of thermal insulation and is the reciprocal of its thermal conductance which, for “slab” materials having substantially parallel faces, is defined as the rate of flow of thermal energy (BTU/hr or Watt) per unit area (square foot=ft² or square meter=m²) per degree of temperature difference (Fahrenheit or Kelvin) across the thickness of the slab material (inches or meters). Inconsistencies in the literature sometimes confuse the intrinsic thermal properties resistivity, r, (and conductivity, k), with the total material properties resistance, R, (and conductance, C), the difference being that the intrinsic properties are defined as being per unit thickness, whereas resistance and conductance (often modified by “total”) are dependent on the thickness of the material, which may or may not be 1 unit. This confusion, compounded by multiple measurement systems, produces an array of complex and confusing units the most common of which are:

| | English | |
|---|---|---|
| | (inch-pound) | Metric/SI units |
| Intrinsic resistivity, r (conductivity, k, is reciprocal) | $\frac{hr * {ft}^{2} * ° F .}{BTU * in}$ | $\frac{K * m}{W}$ |
| Total material resistance, R (conductance, C, is reciprocal) | $\frac{hr * {ft}^{2} * ° F .}{BTU}$ | $\frac{K * {m}^{2}}{W}$ |

For ease of comparisons of materials of differing thicknesses, the building industry sometimes reports thermal resistance (or conductance) per unit thickness (e.g. per inch) effectively converting it to thermal resistivity (conductivity), but retains the traditional symbol, R or R-value.

### Fibrous Product Manufacture

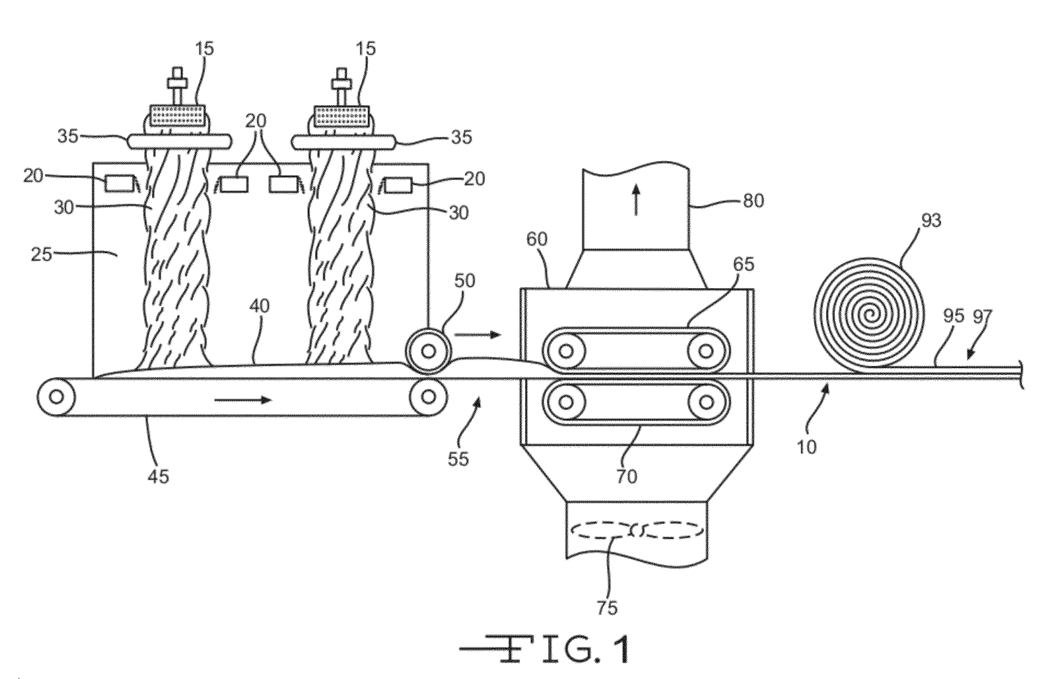

Although other types of fibrous products and manufacturing processes are known, the invention is well exemplified by the manufacture of glass fiber insulation carried out in a continuous process by rotary fiberization of molten glass as depicted in FIG. 1. Glass or other mineral material may be melted in a tank or melter (not shown) and supplied by a forehearth (not shown) to a “fiberizer” or fiber forming device such as a fiberizing spinner 15. The spinners 15 are rotated at high speeds so that centrifugal force causes the molten glass to pass through holes in the circumferential sidewalls of the fiberizing spinners 15 to form primary glass fibers. Secondary glass fibers 30 of random lengths may be attenuated from the fiberizing spinners 15 and blown generally downwardly, that is, generally perpendicular to the plane of the spinners 15, by blowers 20 positioned within a forming chamber 25. It is to be appreciated that the glass fibers 30 may all be the same type of glass or they may be formed of different types of glass, or even of other molten mineral materials. It is also within the purview of the present invention that at least one of the fibers 30 formed from the fiberizing spinners 15 is a dual glass fiber where each individual fiber is formed of two different glass compositions. The glass fibers 30 may have a diameter from about 2 to about 9 microns, or from about 3 to about 6 microns.

The blowers 20 direct the fibers 30 toward a foraminous chain or conveyor 45 to form a fibrous pack 40. The glass fibers, while in transit in the forming chamber 25 and while still hot from the drawing operation, are sprayed with a binder composition by an annular spray ring 35 so as to result in a distribution of the binder composition throughout the formed insulation pack 40 of fibrous glass. Coolant such as water may also be applied to the glass fibers 30 in the forming chamber 25, typically by spraying using a ring system similar to ring 35. Often coolant water is applied prior to the application of the aqueous binder composition to at least partially cool the glass fibers 30. The binder is typically applied in an amount from about 1% to 30% by weight of the total fibrous product, more usually from about 2% to about 20% or from about 3% to about 17%. Binder content of the fibrous products is typically measured by loss on ignition or “LOI” of the cured product.

The glass fibers 30 having the uncured resinous binder adhered thereto may be gathered and formed into an uncured insulation pack 40 on an endless forming conveyor 45 within the forming chamber 25 with the aid of a vacuum (not shown) drawn through the fibrous pack 40 from below the forming conveyor 45. The residual heat from the glass fibers 30 and the flow of air through the fibrous pack 40 during the forming operation are generally sufficient to volatilize a majority of the water from the binder before the glass fibers 30 exit the forming chamber 25, thereby leaving the remaining components of the binder on the fibers 30 as a viscous or semi-viscous high-solids liquid.

The coated fibrous pack 40, which is in a compressed state due to the flow of air through the pack 40 in the forming chamber 25, is then transferred out of the forming chamber 25 under exit roller 50 to a transfer zone 55 where the pack 40 vertically expands due to the resiliency of the glass fibers. The expanded insulation pack 40 is then heated, such as by conveying the pack 40 through a curing oven 60 where heated air is blown through the insulation pack 40 to evaporate any remaining water in the binder, cure the binder, and rigidly bond the fibers together. Heated air is forced though a fan 75 through the lower oven conveyor 70, the insulation pack 40, the upper oven conveyor 65, and out of the curing oven 60 through an exhaust apparatus 80. Although only one oven zone is depicted in FIG. 1, there may be multiple zones used to dry and cure the fibrous product. The cured binder imparts strength and resiliency to the insulation blanket 10, depending on the nature and properties of the particular insulation product being manufactured.

Also, in the curing oven 60, the insulation pack 40 may be compressed by upper and lower foraminous oven conveyors 65, 70 to form a fibrous insulation blanket 10. It is to be appreciated that the insulation blanket 10 has an upper surface and a lower surface. In particular, the insulation blanket 10 has two major surfaces, typically a top and bottom surface, and two minor or side surfaces with fiber blanket 10 oriented so that the major surfaces have a substantially horizontal orientation. The upper and lower oven conveyors 65, 70 may be used to compress the insulation pack 40 to give the insulation blanket 10 a predetermined thickness. It is to be appreciated that although FIG. 1 depicts the conveyors 65, 70 as being in a substantially parallel orientation, they may alternatively be positioned at an angle relative to each other (not illustrated).

The curing oven 60 may be operated at a temperature from about 100° C. to about 325° C., or from about 250° C. to about 300° C. The insulation pack 40 may remain within the oven for a period of time sufficient to crosslink (cure) the binder and form the insulation blanket 10.

A facing material 93 may optionally be placed on the insulation blanket 10 to form a facing layer 95. It should be appreciated that a flexible “blanket” insulation product is depicted in FIG. 1, but the insulation product may also be a rigid panel or board-type insulation product. Non-limiting examples of suitable facing materials 93 include fiberglass mats, Kraft paper, a foil-scrim-Kraft paper laminate, recycled paper, and calendared paper. The facing material 93 may be adhered to the surface of the insulation blanket 10 (board) by a bonding agent (not shown in FIG. 1) to form a faced insulation product 97. When sufficiently flexible, the faced fibrous insulation 97 may subsequently be rolled for storage and/or shipment or cut into predetermined lengths by a cutting device (not illustrated). Such faced insulation products may be used, for example, as panels in basement finishing systems, as ductwrap, ductboard, as faced residential insulation, as construction panels for walls and ceilings, and as pipe insulation.

Fibrous products are generally formed of matted fibers, often bonded together by a cured thermoset or thermoplastic polymeric material. Examples of suitable fibers include mineral fibers such as glass fibers, wool glass fibers, rock, basalt, slag and ceramic fibers. For example, the glass fibers may be produced from a variety of natural minerals or manufactured chemicals such as silica sand, limestone, and soda ash. Other ingredients may include calcined alumina, borax, feldspar, nepheline syenite, magnesite, and kaolin clay. Optionally, other fibers such as natural fibers and/or synthetic fibers such as polyester, polyethylene, polyethylene terephthalate, polypropylene, polyamide, polyvinyl alcohol, aramid, and/or polyaramid fibers may be present in the insulation product in addition to the glass fibers. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cellulose, basalt, cotton, jute, bamboo, ramie, bagasse, hemp, coir, linen, kenaf, sisal, flax, henequen, and combinations thereof. Insulation products may be formed entirely of one type of fiber, or they may be formed of a combination of types of fibers. For example, the insulation product may be formed of combinations of various types of glass fibers or various combinations of different inorganic fibers and/or natural fibers depending on the desired application for the insulation. While other natural, polymeric and mineral fibers are known, the embodiments described herein are primarily with reference to glass fiber insulation products.

The term “fibrous products” is general and encompasses a variety of articles of manufacture. This has already been noted and is evident from table B, below. “Fibrous products” may be characterized and categorized by many different properties, one of which is density. Density may range broadly from about 0.2 pounds/cubic foot (“pcf”) to as high as about 10 pcf, depending on the product. Low or light density insulation batts and blankets typically have densities between about 0.2 pcf and about 5 pcf, more commonly from about 0.3 to about 4 pcf, and have applications rates of about 2-13% LOI. Products such as residential insulation batts may fall in this group.

Fiberglass insulation products can be provided in other forms including board (a heated and compressed batt) and molding media (an alternative form of heated and compressed batt) for use in different applications. Fibrous products also include higher density products having densities from about 10 to about 20 pcf, (and often having binder LOI in excess of 12%) and medium density products more typically having a density from about 1 pcf to about 10 pcf, (and having binder LOI of about 7-16 wt % LOI) such as boards and panels. Medium and higher density insulation products may be used in industrial and/or commercial applications, including but not limited to metal building insulation, pipe or tank insulation, insulative ceiling and wall panels, duct boards and HVAC insulation, appliance and automotive insulation, etc.

Another property useful for categorization is the rigidity of the product. Residential insulation batts are typically quite flexible and they can be compressed into rolls or batts while recovering their “loft” upon decompression. In contrast, other fibrous products, such as ceiling tiles, wall panels, foundation boards and certain pipe insulation to mention a few, are quite rigid and inflexible by design. These products will flex very little and are unlikely to be adapted or conformed to a particular space.

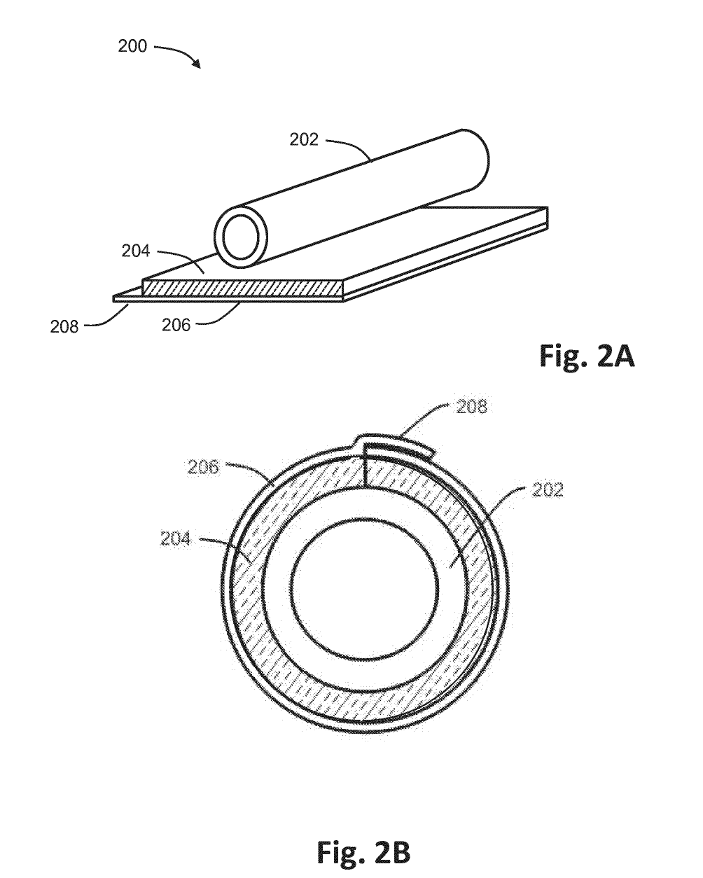

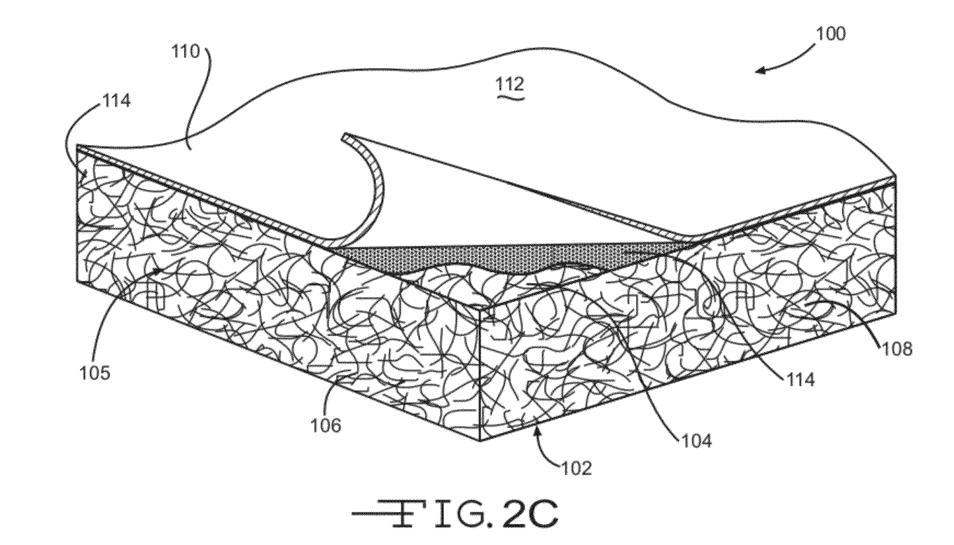

In one embodiment, the insulation product may be a pipe insulation product 200, as generally shown in FIGS. 2A and 2B. Insulation product 200 includes a water resistant insulation material 204, such as made according to the invention described herein, and a facing 206. Insulation product 200 may also optionally include a second facing (not shown) on the opposite side of insulation material 204. A pipe 202 is wrapped with insulation product 200, which is secured via adhesive tab 208, which may be part of facing 206 or a separate component attached thereto. In this manner, pipe 202 is insulated against heat transfer from the surrounding environment.

The water resistance of insulation material 204 provides improved insulation characteristics in, for example, humid environments where pipe 202 may be carrying a coolant or other material. In this scenario, any condensation on the pipe 202 is not likely to be significantly wicked into insulation material 204, which lessens the insulation material's thermal resistance (R-value). One specific example of pipe insulation is disclosed in U.S. Pat. No. 4,022,248, which is hereby fully incorporated by reference. The present invention is not limited to the specific embodiments of pipe insulation products disclosed herein and is widely applicable to the insulation of pipes independent of the specific structures and components used to attached insulation material 204 to a pipe.

In another embodiment shown in FIG. 2C, the fibrous product is a fairly rigid “construction panel” 100 having a medium density from about 2 to about 8 pcf. These “construction panels” often have insulative properties as against sound transfer and/or the transfer of heat or cold—by convection, conduction or both. R-values may range from about R1 to about R20, depending in part on thickness and density. The construction panel 100 is formed as a board 105 or blanket of fibers held together by a curable binder as described above. The panels are generally planar, have opposing major surfaces 102, 104 and multiple edge faces such as 106, 108. Panels or boards are typically fairly rigid.

In particular embodiments, the construction panel is a wall or ceiling panel that further includes a facing layer 110 having a decorative finish or surface 112 adhered to a board 105. The surface 112 may be white, or be painted white, particularly for ceiling panels; or any other color for wall panels. The surface 112 may offer textural or finish properties as well. Such construction panels may be used in above grade or below grade installations. As with the facing material 93 described above, this facing layer 110 may be applied to the fibrous product matrix or board 105 with a bonding agent or adhesive 114, including water-based adhesive, as described below. The facing layer 110 may be applied during manufacture of the fibrous board or, alternatively, it may be applied post manufacture, by a customer such as an intermediate handler or an end-user.

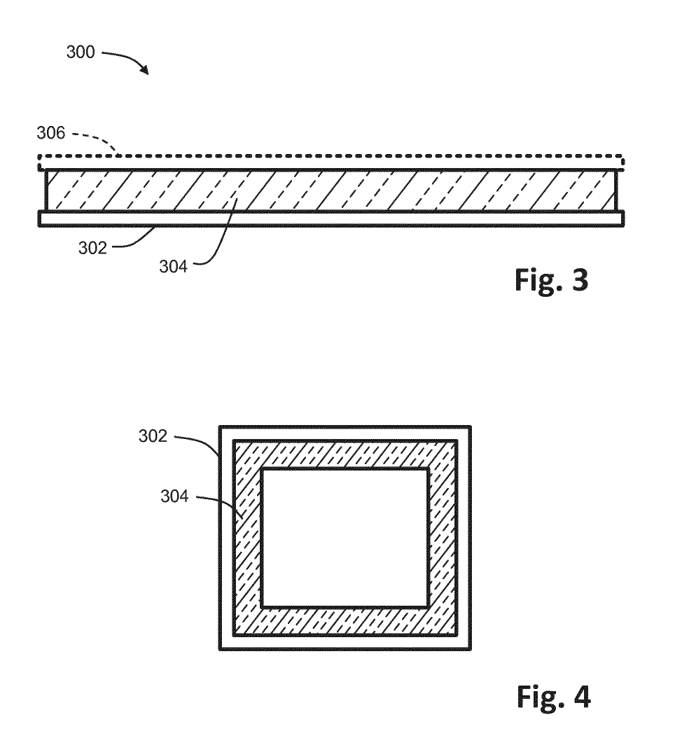

FIG. 3 illustrates another embodiment of an insulation board 300. Insulation board 300 includes a water resistant insulation material 304 that can have a facing layer 302 joined or applied the thereto. The water resistant insulation material 304 is manufactured according to the process herein described. In this embodiment, the insulation material 304 may have a greater density thereby making the insulation material stiffer than compared to, for example, a pipe insulation product. An optional second facing 306 may be applied or joined to a second surface of water resistant insulation material 304. Similarly, further facing surfaces or materials may be applied to other exposed insulation material 304 sides resurfaces. The facing material may be made from, for example, paper, cardboard, metal, combinations thereof, etc. and may be rigid or semi-rigid in nature. In this manner, multiple embodiments of insulation boards 300 for various applications may be constructed. In other embodiments, insulation board 300 does not include a facing 302. Examples of insulation board 300 (both faced and unfaced) include ceiling boards, wall boards, foundation boards, roof boards, floor boards and the like.

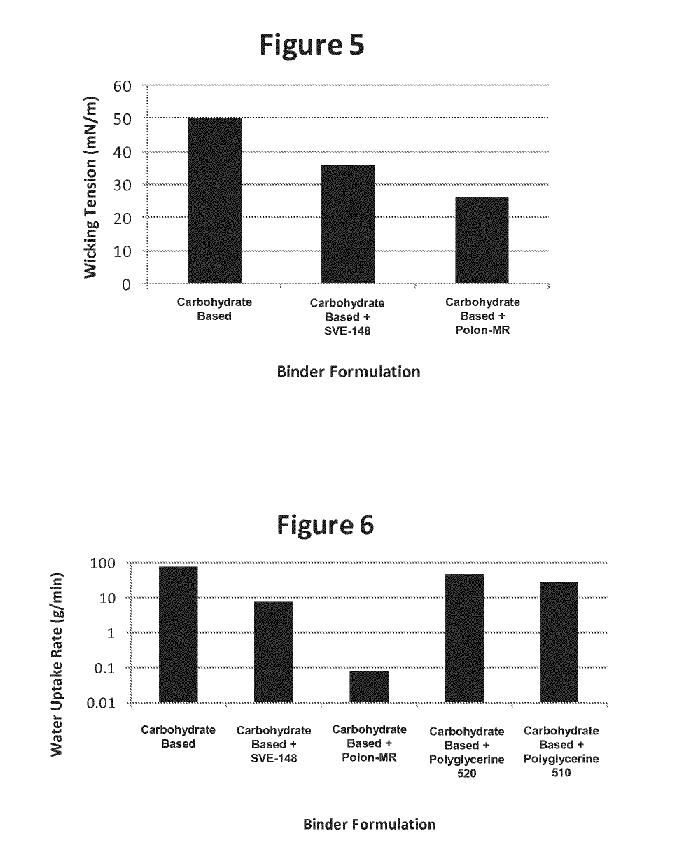

FIG. 4 illustrates an embodiment of a duct made from rigid or semi-rigid insulation boards as shown in cross-section. The duct can be made from a single insulation board which has been notched at appropriate locations to allow for folding into a rectangular or square cross-sectional shape to thereby form the duct itself. Alternatively, the duct can be formed from one or more insulation boards that have been joined together to form the requisite duct geometry.

Suitable bonding agents for attaching a facing layer or “facer” to the fibrous blanket include a wide variety of adhesives and coatings, including hot melt, water-based, dry blended, solvent-based, solventless, bituminous, and film-forming adhesives. Some adhesives are polymers or co-polymers. Most adhesives can be applied by spraying, extrusion, rolling or slot coating the adhesive onto the fibrous matrix and/or the facer. “Facing,” “facing layer” and “facer” are all used interchangeably herein. Some examples of chemistries in dry-blended adhesives include polyvinyl alcohols, starches, and dextrins. Some examples of chemistries found in hot-melt adhesives include ethylene/vinyl acetate (EVA), polyethylene, butyl rubber, poly(styrene-isoprene-styrene) (“SIS”) rubber, poly(styrene-butadiene-styrene) (“SBS”) rubber, polyamides, thermoplastic polyurethanes (TPU), acrylics, polyesters and amorphous polyolephins. Illustrative hot-melt adhesives include Reynco 52-337 PLW and 50-821 PLW from Reynolds Company (Greenville, S.C.).

The water-based adhesives have been found suitable in some embodiments. Some examples of chemistries in water-based adhesives include vinyl acetate, polyvinyl alcohol, starches and dextrins, acrylics, styrene butadiene, ethylene vinyl acetate (“EVA), and styrene acrylics. Illustrative water-based adhesives include DORUS CD 081A (#40-081A) and DORUS PL 0857 (#40-0857) from Henkel Company (Bridgewater, N.J.).

Adhesion of facer layer to the fibrous product is generally measured by a peel test that measures the tensile force necessary to separate the facer layer from a base fibrous layer. ASTM Standard D6862-04 is one such procedure useful for measuring the adhesive strength of a flexible facer layer adhered to a rigid substrate when pulled at an angle of about 90 degrees from the rigid substrate. Other standards and modifications are possible. A consistent application of adhesive is assumed for comparative tests. A tensile strength instrument, such as an Instron instrument, is generally required to record the force required to separate the facer layer. Typically, a force profile is obtained and reported as a maximum force and average force over the duration of the test. An alternative measure of improved adhesion is the achievement of comparable adhesion strength with lesser quantities of adhesive materials. The term “more strongly adheres” refers generally to either stronger adhesion with comparable quantities of adhesive or to comparable adhesion with lesser quantities of adhesive.

Formed or shaped products may include a further step, optionally during cure, that compresses, molds or shapes the product to its specific final shape. Rigid boards are a type of shaped product, the shape being planar. Other shaped products may be formed by dies or molds or other forming apparatus. Rigidity may be imparted by the use of higher density of fibers and/or by higher levels of binder application. As an alternative to rotary fiberizing, some fibrous insulation products, particularly higher density, non-woven insulation products, may be manufactured by an air-laid or wet-laid process using premade fibers of glass, other minerals or polymers that are scattered into a random orientation and contacted with binder to form the product.

Some exemplary fibrous products that can be manufactured according to the invention include those illustrated in Table A below.

TABLE A
Bio-based binder formulations for representative products*

| | Flexible | Metal | | | | |
|---|---|---|---|---|---|---|
| | Duct | Building | Warm & | Ceiling Tile boards | | |
| | Media | Insulation | Dry boards | A | B | C |
| Maltodextrin | 65-70 | 65-70 | 65-70 | 65-70 | 45-60 | 55-60 |
| Citric Acid | 25-30 | 25-30 | 25-30 | 25-30 | 30-35 | 25-35 |
| Sodium | 2-5 | 2-5 | 2-5 | 2-5 | 2-5 | 2-5 |
| hypophosphite | | | | | | |
| Glycerol | | | | | 10-15 | |
| Polyglycol | | | | | | 7-10 |
| Surfactant (e.g. | 0-0.5 | 0-0.5 | 0.1-0.5 | 0.1-0.5 | 0.1-0.5 | 0.1-0.5 |
| SURFYNOL 465) | | | | | | |
| Reactive | 0.01-5.0 | 0.01-5.0 | 0.4-3.0 | 0.01-3.0 | 0.01-3.0 | 0.01-3.0 |
| polysiloxane | | | | | | |

*In Table A above, each ingredient of the binder composition is given as a range of typical values of percentage of dry weight of the binder composition.

A more complete listing of insulation fibrous products that can be manufactured using a bio-based binder composition according to the invention is set forth in Table B, below.

TABLE B
Selected Commercial and Industrial Fibrous Products which may use a Bio-Based Binder

| | | Flexible, Light Density | Rigid Pipe Insulation | Textile E-glass |
|---|---|---|---|---|
| | Rigid Boards | Insulation | and pipe rolls | Nonwoven |
| Density | Wide range of densities— | Light density—Ranging from 0.3 to | Ranging from 3-6 pcf | Ranging from 0.8 to 4 pcf |
| | from 1.5 to 10 pcf | 4.0 pcf | | |
| Binder content | about 2 to about 20% LOI | about 2 to about 13% LOI | about 3 to about 15% LOI | about 5 to about 20% LOI |
| Manufacturing | Rotary fiber forming | Rotary fiber forming process | Rotary fiber forming | Air-laid nonwoven process |
| method | process | | process plus on or offline | |
| | | | molding/pipe formation | |
| | | | process | |
| Exemplary | QUIET R Duct Board | Certified R Metal Building | EVOLUTION Paper-Free | QUIET R Textile Duct |
| Owens Corning | QUIET R Duct Liner | Insulation | ASJ | Liner |
| Products | Board | ELAMINATOR ® Pre-Engineered | VAPORWICK Insulation | DURAFLEX |
| | 700 Series Insulation | Metal Roof Insulation | FIBERGLAS ™ Pipe and | Transportation |
| | Insul-Quick Insulation | MBI Plus | Tank Insulation rolls | |
| | SCR Insulation Board | Metal Bldg Utility Blanket | | |
| | Curtainwall | Unfaced Metal Building Insulation | | |
| | QuietZone Shaftwall | for Canada | | |
| | Warm-N-Dri | Flexible Duct Media Insulation | | |
| | Energy Board | QUIET R Rotary Duct Liner | | |
| | TremDrain | SOFTR Duct Wrap FRK | | |
| | Exterior Foundation | TIW Types I and II | | |
| | Barrier Board | FLEX-Wrap for pipes and tanks | | |
| | Ceiling Board Blanks | H2V Series | | |
| | | RA Series | | |
| | | Select Sound | | |
| | | Thermorange | | |
| | | FlameSpread 25 | | |
| | | Sonobatts | | |
| | | Thermal Batts | | |

Insulation products such as construction panels 100 having finished facings or layers 110 stand to benefit from the inventive methods. These products generally have finished surfaces 112 designed to be the outermost layer of ceilings or walls in buildings such as homes, offices, etc. Thus, the water resistance, stain reducing and discoloration reducing properties of the present invention are particularly useful with these forms of insulation, as is enhanced adhesion with certain adhesives.

### Reactive Polysiloxanes

A feature of the invention is use of reactive polysiloxanes to improve certain properties of the fibrous products. Silicon is tetravalent, analogous to its group IVA relative, carbon; so it tends to form compounds analogous to alkyl compounds, like alkanes. When combined with divalent oxygen, it forms siloxanes analogous to ethers, and these can polymerize to polysiloxanes. The general structure of a polysiloxane (also called “silicones”) may be represented by the formula I:

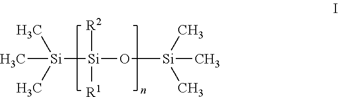

wherein R¹ and R² are lower alkyl or aryl; and n may be about 5 to about 100 or more, more typically from about 20 to about 70. As is typical with polymers, chain length is generally a distribution of lengths with the mean or average length reported. “Lower alkyl”, as used herein means a straight or branched hydrocarbon group having from 1 to 6 carbons. Methyl, ethyl, propyl, isopropyl, n-butyl, isobutyl, t-butyl, pentyl and hexyl are examples of lower alkyl. “Aryl” refers to aromatic ring substituents having from 3 to 8 carbons in the ring, the most common being phenyl or substituted phenyl. In some cases, organic side groups attached to lower alkyl or aryl side chains may contain reactive functional moieties that can be used to crosslink two or more of these —Si—O— backbones together as is known in the art and discussed below.

Some common forms of polysiloxanes include silicone oils, silicone grease, silicone rubber, and silicone resins, depending largely on the value of n and the degree to which the side chains form crosslinking between —Si—O— backbones. Silicones can vary in consistency from liquid to gel to rubber to hard plastic. The most common polysiloxane is linear polydimethylsiloxane (PDMS), a silicone oil. The second largest group of silicone materials is based on silicone resins, which are formed by branched and cage-like oligosiloxanes.

“Reactive polysiloxanes,” as uses herein, refer to polysiloxanes (silicones) of formula II:

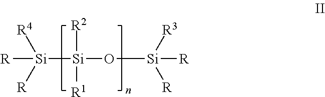

wherein R and each of R¹-R⁴ is independently selected from lower alkyl or aryl, provided that at least one of R¹-R⁴ is or includes a reactive functional group. For purposes of this invention, a “reactive functional group” includes hydride (—H), hydroxyl (—OH), amino (—NH₂), carboxyl (—COOH). Thus, at least one of R¹, R², R³, and R⁴ is a reactive functional group, or is a lower alkyl or aryl substituted with a reactive functional group. The location of the reactive functional group may be important. Reactive functional groups at either of R¹ and R² are “internal” reactive groups and are repeated multiple times with each subunit of the polymer and may be preferred as more reactive. In contrast, reactive functional groups at either of R³ and R⁴ are “terminal” functional groups and each occurs just once per polymer molecule. If no reactive functional group is located at R¹ or R², then preferably both R³ and R⁴ include a reactive functional group.

Polysiloxanes having a reactive hydrogen are among the most common and are referred to as polyalkylhydrogensiloxanes. Polysiloxanes having a reactive amino group are polyalkylaminosiloxanes; polysiloxanes having a reactive hydroxyl group are polyalkylhydroxylsiloxanes; and polysiloxanes having a reactive carboxyl group are polyalkylcarboxylsiloxanes; regardless whether the reactive functional group is attached directly to the silicon atom or to a lower alkyl or aryl attached to the silicon atom.

In contrast to standard polysiloxanes, reactive polysiloxanes are not chemically inert. Rather the reactive functional group enables reactive polysiloxanes to bond with other polysiloxanes and with other reactive groups such as might be found on glass fibers used in fibrous products.

Suitable reactive polysiloxanes are commercially available from a wide variety of sources. Some non-limiting examples of suitable reactive polysiloxanes include: DC-1171, DC-757F and DC-2-887, available from Dow Corning of Midland, Mich.; DF 1040, a polymethylhydrogensiloxane from GE/Bayer; ICM SF-MH, a polymethylhydrogensiloxane from ICM (Cassopolis, Mich.); various ICM product numbers that are polymethylaminosiloxanes from ICM (Cassopolis, Mich.); SVE-148, a reactive silicone emulsion manufactured by Siovation, LLC (Lawrenceville, Ga.; Polon-MR, a reactive silicone emulsion manufactured by Shin-Etsu Chemical Co., Ltd. (Tokyo, Japan); and SILRES® BS 1042, a reactive polydimethylsiloxane from Wacker Silicones (Munchen, Del.). Reactive polysiloxanes can be applied neat (as supplied by manufacturer), or as an aqueous dispersion of reactive polysiloxanes in virtually any dilution. Dispersions include true solutions, suspensions and emulsions. Since the polysiloxanes generally have poor water solubility, oil-in-water emulsions are a particularly suitable mechanism for dispersing polysiloxanes into aqueous media. Application rates in the fibrous product may range from as low as about 0.01% up to about 10% by weight of the fibrous product, more typically up to about 5% or up to about 2.5%. For some ceiling tile products, a target application rate yields about 0.3% to about 0.5% by weight. For some other embodiments, the silicone or polyglycerine additive is used from about 0.01% to about 2.5% depending on the product.

For some products it may be desirable to apply the reactive polysiloxane substantially uniformly throughout the fibrous matrix, while for other products it may be desirable to concentrate the application at or near one of the major surfaces. When a substantially uniform application is preferred, reactive polysiloxanes may be applied during the fiber forming process. For example, solutions or dispersions as noted above may be sprayed in the forming hood, either directly onto the veil of fibers as they are formed (like coolant or binder) or onto the growing pack of fibers on the conveyor. When applied in the forming hood, it may be convenient to apply reactive polysiloxanes mixed in with the coolant liquid and/or with the binder. Thus, in some embodiments, the binder dispersion compositions may include the reactive polysiloxanes as described below. Substantially uniform application is advantageous when the insulation blanket or board as manufactured will be slit, bisected, trimmed, sanded or otherwise cut or abraded to reveal an interior surface, to which a facing layer may be applied.

In other embodiments, it may be preferable to favor reactive polysiloxane application at the upper or lower major surface of the fibrous product. The concentration of polysiloxanes nearer one major surface or the other may enhance the reduction of staining and discoloration, and may enhance the ability to apply a facing layer with water-based adhesives. Concentration of polysiloxanes near a major surface may be achieved by (1) applying the dispersions to already-formed blankets of fibrous product, such as by spraying or brushing, either before or after exit from the oven; or (2) by application in the forming hood at initial fiberizers for concentration at one surface, or at terminal fiberizers for concentration at the opposing surface, while intermediate fiberizers apply little or no polysiloxanes.

Polyglycerine emulsions may substitute for reactive polysiloxanes in the invention. These compounds produce the improved properties of improved (decreased) water absorption and wicking; improved stain resistance; and improved adhesion strength.

### Binder Compositions

Binder compositions are well known in the industry. Binders are typically applied to the fibers as an aqueous solution shortly after the fibers are formed and then cured at elevated temperatures. The curing conditions are selected both to evaporate any remaining solvent and cure the binder to a thermoset state. The fibers in the resulting product tend to be partially coated with a thin layer of the thermoset resin and exhibit accumulations of the binder composition at points where fibers touch or are positioned closely adjacent to each other. In one embodiment, phenol-formaldehyde binders are used with polysiloxane additives to provide increased water and stain resistance to the insulation product. Phenol-formaldehyde binders are generally characterized by relatively low viscosity when uncured, and the formation of a rigid thermoset polymeric matrix with the fibers when cured. A low-viscosity uncured binder simplifies binder application and allows the binder-coated batt to expand more easily when the forming chamber compression is removed. Similarly, the rigid matrix formed by curing the binder allows a finished fiber product to be compressed for packaging and shipping and then recover to substantially its full original dimension when unpacked for installation.

In other embodiments, formaldehyde-free binders may also be used in combination with additives that increase the insulation products resistance to water. Nonphenol/formaldehyde binders exhibit low uncured viscosity and structural rigidity when cured. One such binder composition is disclosed in U.S. Pat. No. 5,318,990, which is herein incorporated, in its entirety, by reference, and utilizes a polycarboxy polymer, a monomeric trihydric alcohol and a catalyst comprising an alkali metal salt of a phosphorous containing organic acid. Other binder compositions have also been developed to provide reduced emissions during the coating and curing processes utilizing compounds such as polyacrylic acid as disclosed in U.S. Pat. Nos. 5,670,585 and 5,538,761, which are herein incorporated, in their entirety, by reference.

Although the invention may be employed with traditional phenol-formaldehyde (PF) or phenol-urea-formaldehyde (PUF) binders, in other embodiments, the invention is employed with formaldehyde-free binders, such as polyacrylic acid binders utilizing as described in U.S. Pat. Nos. 6,884,849 and 6,699,945 to Chen, et al. Another polyacrylic binder composition is disclosed in U.S. Pat. No. 5,661,213, which teaches an aqueous composition comprising a polyacid, a polyol and a phosphorous-containing accelerator, wherein the ratio of the number of equivalents of the polyacid to the number of equivalents of the polyol is from about 100:1 to about 1:3 and is hereby fully incorporated by reference. As disclosed in U.S. Pat. No. 6,399,694, which hereby also fully incorporated by reference, another alternative to the PUF binders utilizes polyacrylic acid and either glycerol (PAG) or triethanoloamine (PAT) as a binder. PAG/PAT binders are relatively odorless, more uniformly coat each fiber and have a generally white or light color.

Also useful are binders made from natural starches (or dextrins, maltodextrins or other polysaccharides of varying length) and polyfunctional carboxylic acids like citric acid (MD/CA), such as those WO 2011/044490, published Apr. 14, 2011, all incorporated by reference. These polyhydroxyl-carboxylic acid-based binder systems, however, are also described herein.

Polyhydroxyl Compounds

By definition, the polyhydroxy compound or polyol is polyvalent, having two or more hydroxyl groups that can be available for reaction. While a polyol has a minimum of two hydroxyl groups, there is no theoretical maximum number of hydroxyl groups. Diols, triols, tetraols, penta-ols, hexa-ols and higher polyols are all encompassed, particularly in polymeric compounds. The polyol may be monomeric or polymeric; and may be natural or synthetic. In some embodiments, the polyol may be smaller monomeric compounds like glycerol, ethylene glycol, propanediols, propanetriols, trimethylol propane, erythritol or other butane-based polyols, pentaeythritol, triethanoloamine (TEA), or 1,2,6-hexane-triol; or any monosaccharide having at least 4 carbons, including pentoses and hexoses.

In other embodiments, the polyol may be a synthetic or naturally occurring polymer, such as polyvinyl alcohol, poly(ether)polyols, poly(ester)polyols, polyethylene glycol, polyol- and hydroxy-functional acrylic resins such as JONCRYL® (BASF Resins), MACRYNAL® (Cytec Industries) PARALOID® (Dow Coating Materials), G-CURE®, TSAX® and SETALUX® (Nuplex Resins, LLC) in solution or emulsion form; or di-, tri- and higher polysaccharides.

Due to the wide variability in molecular weights of the polyol component and (as discussed below) the crosslinking agent, the weight ratios of the various components of the binder composition can vary tremendously. Thus, polyol (polyhydroxyl) component may be present in the binder composition in an amount from about 1% to about 99% by weight of the total solids in the binder composition, more likely from about 20% to about 99% by weight of the total solids in the binder composition. As used herein, % by weight indicates % by weight of the total solids in the binder composition.

In some exemplary embodiments, the saccharide polyol component is a carbohydrate and the binder and includes a carbohydrate and a crosslinking agent. In some exemplary embodiments, the carbohydrate-based binder composition also includes a coupling agent, a process aid agent, an extender, a pH adjuster, a catalyst, a crosslinking density enhancer, a deodorant, an antioxidant, a dust suppressing agent, a biocide, a moisture resistant agent, a surfactant, or combinations thereof. The binder may be used in the formation of many insulation materials, including but not limited to construction panels. In addition, the binder is free of added formaldehyde. Further, the binder composition has a reduction in particulate emission compared to conventional phenol/urea/formaldehyde binder compositions. The inventive binder may also be useful in forming particleboard, plywood, and/or hardboards.

In one or more exemplary embodiments, the binder includes at least one carbohydrate that is natural in origin and derived from renewable resources. For instance, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate polymer may also be derived from crude starch-containing products derived from plants that contain residues of proteins, polypeptides, lipids, and low molecular weight carbohydrates.

As noted, the carbohydrate may be selected from monosaccharides, including but not limited to erythrose, erythulose, threose, ribose, ribulose, arabinose, xylose, xylulose, glucose, dextrose (or D-glucose), mannose, glactose, fructose, and sorbose; disaccharides, including but not limited to maltose, sucrose, lactose, cellobiose and trehalose; oligosaccharides (e.g., glucose syrup and fructose syrup); and polysaccharides (e.g., pectin, dextrin, maltodextrin, starch, modified starch, and starch derivatives), provided they can be prepared as water dispersions, which includes emulsions, suspensions, colloids and true solutions. All isomeric and stereochemical forms of these saccharides are encompassed in the invention. Furthermore, derivatives of saccharides may also be suitable, provided they retain their polyvalent polyol nature after derivatization. Thus, the polyol may include O-glycosides, N-glycosides, S-glycosides, C-glycosides, O-alkyl (e.g. methyl, ethyl), O-acylated sugars, amino sugars, sugar alcohols (like sorbitol, xylitol, erythritol, etc.) and the like.

The carbohydrate polymer may have a number average molecular weight from about 1,000 to about 8,000. Additionally, the carbohydrate polymer may have a dextrose equivalent (DE) number from 2 to 20, from 5 to 15, or from 7 to 12. The carbohydrate dispersions beneficially have a low viscosity and cure at moderate temperatures (e.g., 80-250° C.) alone or with additives. The low viscosity enables the carbohydrate to be utilized in a binder composition. The use of a carbohydrate in the inventive binder composition is advantageous in that carbohydrates are readily available or easily obtainable and are low in cost.

In at least one exemplary embodiment, the carbohydrate is a water-soluble polysaccharide such as dextrin or maltodextrin. The carbohydrate polymer may be present in the binder composition in an amount from about 40% to about 90% by weight of the total solids in the binder composition, from about 45% to about 85% by weight of the total solids in the binder composition, from about 50% to about 80%, or from about 55% to about 75%.

Polycarboxylic Acid Crosslinking Agents

In addition, the binder composition contains a polycarboxylic acid crosslinking agent suitable for crosslinking the polyhydroxyl compound. In exemplary embodiments, the crosslinking agent has a number average molecular weight greater than 90, from about 90 to about 10,000, or from about 190 to about 4,000. In some exemplary embodiments, the crosslinking agent has a number average molecular weight less than about 1000. Non-limiting examples of suitable crosslinking agents include di-, tri- and polycarboxylic acids (and salts thereof), anhydrides, monomeric and polymeric polycarboxylic acid with anhydride (i.e., mixed anhydrides), malonic acid, succinic acid, glutaric acid, maleic acid, citric acid (including salts thereof, such as ammonium citrate), 1,2,3,4-butane tetracarboxylic acid, adipic acid, polyacrylic acid, and polyacrylic acid based resins such as QXRP 1734, 1629 and Acumer 9932, all commercially available from The Dow Chemical Company. In exemplary embodiments, the crosslinking agent may be any monomeric or polymeric polycarboxylic acid, citric acid, and their corresponding salts. For each type of acid, it should be understood that acid salts may also be used in place of the acids.

The crosslinking agent may be present in the binder composition in an amount up to about 50% by weight of the binder composition. In exemplary embodiments, the crosslinking agent may be present in the binder composition in an amount from about 20% to about 40% by weight of the total solids in the binder composition or from about 25% to about 35% by weight.

Other Optional Ingredients of the Binder Compositions

Typically, the binder composition may include a catalyst to assist in the crosslinking. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Bronsted or Lewis bases (i.e., polyethyleneimine, diethylamine, or triethylamine). Additionally, the catalyst may include an alkali metal salt of a phosphorous-containing organic acid; in particular, alkali metal salts of phosphorus acid, hypophosphorus acid, or polyphosphoric acids. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexamethaphosphate, potassium phosphate, potassium tripolyphosphate, sodium trimetaphosphate, sodium tetramethaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also or alternatively be used as the catalyst/accelerator, as well as some lithium and zirconium complexes. Carbodiimide based coupling agents like and not limited to 1-ethyl-3-(3-dimethylaminopropyl) carbodiimide (EDCI) or N,N′-Dicyclohexylcarbodiimide (DCC) could be used as well. The catalyst or cure accelerator may be present in the binder composition in an amount from about 0% to about 10% by weight of the total solids in the binder composition, or from about 1.0% to about 5.0% by weight, or from about 3.0% to about 5.0% by weight.

As detailed in WO 2011/044490, the binder composition may optionally contain a wide range of other additives, the details of which are omitted here. These might include at least one coupling agent, which may be present in an amount from about 0.00% to about 5.0% by weight of the total solids in the binder composition, from about 0.01% to about 2.5% by weight, or from about 0.1% to about 0.5% by weight. Silane coupling agents are commonly used in glass fiber products. Non-limiting examples of silane coupling agents may include those characterized by the functional groups alkyl, aryl, amino, epoxy, vinyl, methacryloxy, ureido, isocyanato, and mercapto.

In addition, the binder composition may include a processing aid to facilitate the processing of the fibers formation and orientation. Examples of processing aids include viscosity modifiers, defoaming agents, surfactants (including anionic, cationic, non-ionic and zwitterionic) and lubricants. Additionally, binder compositions may optionally include; a biocide; a crosslinking density enhancer to improve the degree of crosslinking; organic and/or inorganic acids and bases in an amount sufficient to adjust and/or buffer the pH to a desired level; a moisture resistant agent; a dust suppressing agent to reduce or eliminate the presence of inorganic and/or organic particles; fillers or extenders to improve the binder's appearance and/or to lower the overall manufacturing cost; and conventional additives such as, but not limited to dyes, pigments, colorants, UV stabilizers, thermal stabilizers, lubricants, anti-foaming agents, anti-oxidants, emulsifiers, preservatives (e.g., sodium benzoate), corrosion inhibitors, and mixtures thereof.

The reactive polysiloxanes described above may also be included in the binder dispersions, as previously noted.

### EXAMPLES

The following examples serve to further illustrate the invention.

### Example 1

### Preparation of a Binder

Four sample binders are prepared having the formulations described in Table C, below. Samples 1 and 2 have the same DE, but different ratios of maltodextrin (MD) to citric acid crosslinker (CA); samples 2 and 3 have the same ratio of MD to CA but a different DE. Sample 4 is a polyacrylic acid (PA) binder rather than a carbohydrate based binder. Samples 1 to 4 are prepared in duplicate, once with and once without the reactive silicone component for comparative purposes. The reactive silicone is blended into the oil emulsion; other solids and solutions are gradually blended into the water with agitation.

TABLE C
Binder Formulations

| | Sample 1 | Sample 2 | Sample 3 | Sample 4 |
|---|---|---|---|---|
| | 70:30 MD-CA | 55:35:10 MD-CA- | 55:35:10 MD-CA- | 55:45 |
| | w/5% SHP | G w/5% SHP | G w/5% SHP | MD-PA |
| Component | (DE = 11) | (DE = 11) | (DE = 5) | (DE = 11) |
| Maltodextrin (MD)- | 1237.8 lbs | 972.5 lbs | — | 1020.9 lbs |
| DE = 11 (50% Solids) | | | | |
| Maltodextrin (MD- | — | — | 972.5 lbs | — |
| DE = 5 (50% Solids) | | | | |
| Citric Acid (CA) | 530.5 lbs | 618.9 lbs | 618.9 lbs | — |
| (50% Solids) | | | | |
| QRXP-1629— | — | — | — | 888.6 lbs |
| Polyacrylic Acid (PA) | | | | |
| (47% Solids) | | | | |
| Sodium | 106.5 lbs | 106.5 lbs | 106.5 lbs | — |
| Hypophosphite (SHP) | | | | |
| (41.5% Solids) | | | | |
| Glycerol (G) | | 88.4 lbs | 88.4 lbs | — |
| (100% Solids) | | | | |
| Reactive Silicone | 19.0 lbs | 19.0 lbs | 19.0 lbs | — |
| (DF-1040) | | | | |
| (100% Solids) | | | | |
| Reactive Silicone | — | — | — | 19.0 lbs |
| (BS-1042) | | | | |
| (100% Solids) | | | | |
| Surfynol 465 | 4.4 lbs | 4.4 lbs | 4.4 lbs | 4.4 lbs |
| (100% Solids) | | | | |
| Oil Emulsion | 100.8 lbs | 100.8 lbs | 100.8 lbs | 100.8 lbs |
| (50% Solids) | | | | |
| gamma-aminopropyl- | 142.8 lbs | 142.8 lbs | 142.8 lbs | 142.8 lbs |
| trihydroxy-silane | | | | |
| (1.24% solution) | | | | |
| Water | 2343.4 lbs | 2416.6 lbs | 2416.6 lbs | 2314.6 lbs |

### Example 2

### Testing for Stain/Discoloration

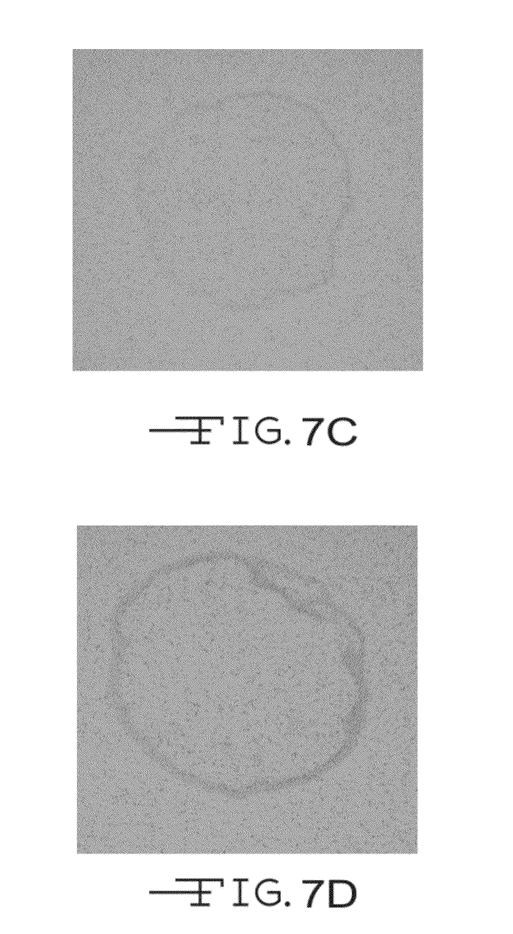

Ceiling tiles are prepared with sample binders from Table C. Tile sample 2 was prepared with binder sample 2 with the DF1040 reactive silicone. Tiles samples 1, 3 and 4 were prepared with binder samples 1, 3, and 4, respectively, without the reactive silicone. A 10 ml quantity of water was poured onto the ceiling tiles in several locations. Brown stain spots appeared in several locations in tile samples 1, 3 and 4. Tile sample 2, with the reactive silicone, produced significantly less staining than the tile samples without silicone. The results are displayed in portions of the tiles shown in FIGS. 7A to 7D, wherein 7A is from tile sample 1, 7B is from tile sample 2, 7C is from tile sample 3 and 7D is from tile sample 4.

### Example 3

### Testing for Facing Adhesion

Ceiling tiles are prepared with sample binders from Table C. Tile sample 2 was prepared with binder sample 2 with the reactive silicon; tile sample 3 was prepared with binder sample 3 without the reactive silicone; and tile sample 4 was prepared both with (4+) and without (4-) the reactive silicone. A facer layer was applied to the fibrous product substrate using a proprietary water-based adhesive. An Instron tensile strength instrument was used in a 90 degree peel test to measure the adhesive strength. The results, displayed in Table D below, show that the reactive silicone of sample 4 produced a marginal increase in adhesion strength. Although the DE varies in samples 2 and 3, the ratio of MD to CA does not and this reactive silicone produced a market improvement in adhesion.

TABLE D
Ceiling tiles and adhesive peel test results

| Sample | | Reactive | Max Load | Average Load |
|---|---|---|---|---|
| # | Binder Used in the Board | Silicone | (lbs) | (lbs) |
| 2. | 55:35:10 MD-CA-G | Yes | 0.889 | 0.299 |
| | w/5% SHP (DE = 11) | | | |
| 3. | 55:35:10 MD-CA-G | No | 0.514 | 0.185 |
| | w/5% SHP (DE = 5) | | | |
| 4+. | 55:45 MD-PA (DE = 11) | Yes | 0.761 | 0.288 |
| 4−. | 55:45 MD-PA (DE = 11) | No | 0.689 | 0.249 |

### Example 4

### Testing for Wicking Tension

Handsheets were prepared from wet-chopped fiberglass at laboratory scale and coated with various embodiments of carbohydrate-based binder compositions similar to Samples 1-3 of Example 1. One handsheet was prepared without reactive silicone as a control. A second handsheet contained SVE-148, a reactive silicone emulsion additive manufactured by Siovation, LLC of Lawrenceville, Ga.; and a third handsheet contained Polon-MR, a reactive silicone emulsion additive manufactured by Shin-Etsu Chemical Co., Ltd. of Tokyo, Japan. After curing and allowing the sheets to cool, droplets of water solutions containing increasing amounts of ethanol were placed on the surface of each handsheet. The wicking tension corresponds to the surface tension of the solution with the lowest ethanol content that was absorbed by the handsheet.

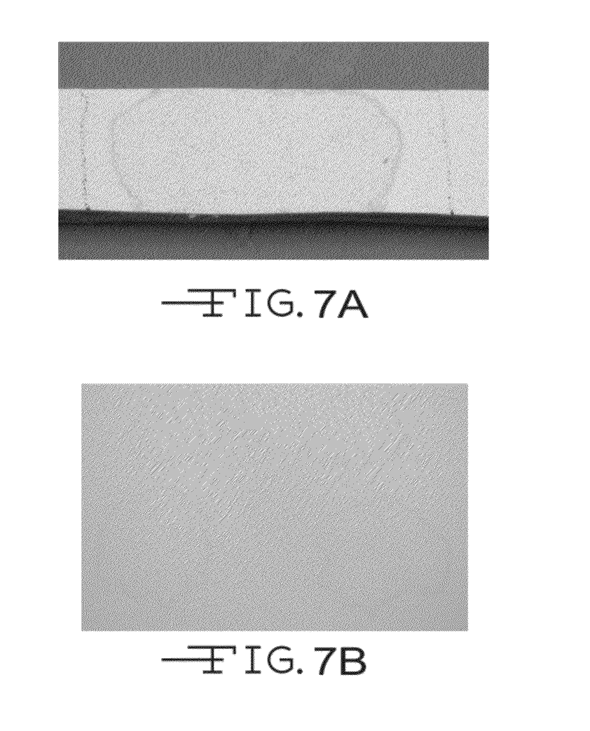

FIG. 5 illustrates the water resistance. It can be readily observed that the carbohydrate-based binders having the reactive silicone emulsion additives exhibit a lower wicking tension, which translates into increased water resistance. Of the three example, the third having the Polon-MR reactive silicone emulsion additive exhibited the lowest wicking tension or highest water resistance.

### Example 5

### Testing for Water Absorption

Ceiling boards were prepared using binders as described above and having the additive specified in Table E below. Samples 5-7 contain the same binders as in Example 4. Samples 8 and 9 were made with two types of polyglycerine (having different amounts of free glycerine). Sections of 5″×5″ boards were floated in a container of water and the total amount of water absorbed within a fixed time was measured.

TABLE E
Carbohydrate-based Binder Formulations

| | Sample 5 | | | | |
|---|---|---|---|---|---|
| | (control) | Sample 6 | Sample 7 | Sample 8 | Sample 9 |
| Additive | none | SVE-148 | Polon-MR | Polyglycerine | Polyglycerine |
| | | | | 520 | 510 |

FIG. 6 illustrates the water uptake rate for binder composition Samples 5 to 9. It can be seen that the carbohydrate-based binder compositions having the reactive silicon emulsion and polyglycerine additives absorbed water at a lower rate than the carbohydrate-based additive absent the additives. Once again, the carbohydrate-based binder having the Polon-MR reactive silicone additive had the lowest water absorption rate.

The foregoing description of the various aspects and embodiments of the present invention has been presented for purposes of illustration and description. It is not intended to be exhaustive or all embodiments or to limit the invention to the specific aspects disclosed. Additional advantages and modifications will readily appear to those skilled in the art. For example, polyglycerine may reduce the total amount of moisture necessary to induce the desired expansion of the binder-coated glass mat in the transfer zone between the forming chamber and the curing oven, thus reducing the total energy consumption of the oven during curing. Furthermore, silicone emulsions tend to provide lubricity to the cured binder that may facilitate the disengagement of glass fibers from the conveyor upon discharge from the curing oven. Obvious modifications or variations are possible in light of the above teachings and such modifications and variations may well fall within the scope of the invention as determined by the appended claims when interpreted in accordance with the breadth to which they are fairly, legally and equitably entitled.

What is claimed is:

1. A method of improving the resistance to staining or discoloration of a fibrous product construction panel, the method comprising:
forming the fibrous product from a plurality of mineral fibers, and
applying a reactive polysiloxane to at least some of the fibers of the fibrous product, wherein the fibrous product is more resistant to staining or discoloration than a fibrous product made without the reactive polysiloxane.

2. The method of claim 1, wherein the reactive polysiloxane is a polymer having from about 5 to about 100 siloxane units, each unit having a reactive functional group.

3. The method of claim 1, wherein the reactive polysiloxane is selected from a polyalkylamino siloxane and a polyalkylhydroxyl siloxane.

4. The method of claim 1, wherein the reactive polysiloxane is a polyalkylhydrogen siloxane.

5. The method of claim 4, wherein the reactive polysiloxane is a polymethylhydrogen siloxane.

6. The method of claim 1, further comprising applying the reactive polysiloxane substantially uniformly throughout the fibrous product.

7. The method of claim 1, further comprising applying the reactive polysiloxane non-uniformly to be concentrated near at least one major surface the fibrous product.

8. The method of claim 1, further comprising applying a facing to the fibrous product.

9. The method of claim 8, wherein the construction panel is selected from a ceiling panel, a wall panel and a duct board.

10. The method of claim 1, wherein applying a reactive polysiloxane further comprises applying a binder composition to at least a portion of the fibers in the fibrous product, wherein the binder composition contains (a) a thermosetting, curable binder system comprising a polyhydroxyl compound and a polycarboxylic acid crosslinking agent; and (b) a reactive polysiloxane.

11. The method of claim 10, wherein the polyhydroxyl compound comprises a polysaccharide selected from a starch, a maltodextrin, a dextrin and a syrup.

12. The method of claim 11, wherein the polycarboxylic acid crosslinking agent is selected from a polyacrylic acid and an organic di- or tri-carboxylic acid.

13. The method of claim 12, wherein the polycarboxylic acid crosslinking agent is citric acid and the polyhydroxyl compound comprises a maltodextrin.

14. The method of claim 10, wherein the polyhydroxyl compound is a monosaccharide, disaccharide or combination thereof.

15. A method of improving the facing adhesion properties of a fibrous product construction panel, the method comprising:
forming the fibrous product from a plurality of mineral fibers;
applying a reactive polysiloxane to at least some of the fibers of the fibrous product; and
applying a facing to the fibrous product with an adhesive;
wherein the facing more strongly adheres to the fibrous product than to a fibrous product made without the reactive polysiloxane.

16. The method of claim 15, wherein the reactive polysiloxane is a polymer having from about 5 to about 100 siloxane units, each unit having a reactive functional group.

17. The method of claim 15, wherein the reactive polysiloxane is selected from a polyalkylamino siloxane and a polyalkylhydroxyl siloxane.

18. The method of claim 15, wherein the reactive polysiloxane is a polyalkylhydrogen siloxane.

19. The method of claim 15, further comprising applying the reactive polysiloxane substantially uniformly throughout the fibrous product.

20. The method of claim 15, further comprising applying the reactive polysiloxane non-uniformly to be concentrated near at least one major surface the fibrous product.

21. The method of claim 15, wherein the construction panel is selected from a ceiling panel, a wall panel and a duct board.

22. The method of claim 15, wherein applying a reactive polysiloxane further comprises applying a binder composition to at least a portion of the fibers in the fibrous product, wherein the binder composition contains (a) a thermosetting, curable binder system comprising a polyhydroxyl compound and a polycarboxylic acid crosslinking agent; and (b) a reactive polysiloxane.

23. The method of claim 22, wherein the polyhydroxyl compound comprises a polysaccharide selected from a starch, a maltodextrin, a dextrin and a syrup.

24. The method of claim 23, wherein the polycarboxylic acid crosslinking agent is selected from a polyacrylic acid and an organic di- or tri-carboxylic acid.

25. The method of claim 24, wherein the polycarboxylic acid crosslinking agent is citric acid and the polyhydroxyl compound comprises a maltodextrin.

26. The method of claim 22, wherein the polyhydroxyl compound is a monosaccharide, disaccharide or combination thereof.

27. A method of improving the water resistance of a fibrous insulation product, the method comprising:
forming the fibrous product from a plurality of mineral fibers, and
applying a binder composition to at least a portion of the fibers in the fibrous product, wherein the binder composition contains (a) a curable binder system comprising a polyhydroxyl compound and a polycarboxylic acid crosslinking agent; and (b) a silicone additive, wherein the insulation product exhibits reduced water absorption or wicking tension compared to an insulation product made without the silicone additive.

28. The method of claim 27, wherein the additive is a reactive polysilicone.

29. The method of claim 27, wherein the insulation product is selected from a ceiling panel, a wall panel, a duct board, pipe insulation and molded media.
